(19) United States
(12) Patent Application Publication
(10) Pub. No.: US 2008/0236424 A1
(43) Pub. Date: Oct. 2, 2008

(54) LETTERPRESS PRINTING FORM, IN PARTICULAR FLEXOGRAPHIC PRINTING FORM, AND METHOD FOR ITS PRODUCTION

(76) Inventor: Malte Juergensen, Rickert (DE)

Correspondence Address: SCHIFF HARDIN, LLP;PATENT DEPARTMENT, 6600 SEARS TOWER, CHICAGO, IL, 60606-6473, US

(21) Appl. No.: 12/050,290

(22) Filed: Mar. 18, 2008

(30) Foreign Application Priority Data
Mar. 27, 2007 (DE) 10 2007 015 263.0

(51) Int. Cl. B41N 1/00; B41N 3/00

(52) U.S. Cl. 101/453; 101/463.1

(57) ABSTRACT

In a letterpress printing form, at least one region at a floor of the printing form is formed between printing elements to reduce a likelihood that printing ink drops which may form at a floor between the printing elements could detach from the floor and result in an undesired ink deposit on a surface being printed.

### BACKGROUND

The preferred embodiment concerns a method for production of a letterpress printing form, in particular a flexographic printing form, advantageously with at least one processing unit for material milling (in particular with a laser). The letterpress printing form exhibits printing elements elevated above a floor, and advantageously exhibits raster points arranged according to a raster.

Furthermore, the preferred embodiment concerns a letterpress printing form that is advantageously produced according to the aforementioned method.

The most common method of letterpress printing today is what is known as flexographic printing. In contrast to classical book letterpress printing, for flexographic printing relatively elastic, soft, rubber-like printing forms are provided in which the printing elements have been raised. The printing forms are for the most part produced from rubber or a photopolymer. For example, a printing form made from rubber with a casting mold can be produced with its printing elements. By now it has become typical to use photopolymers that can be locally cross-linked via exposure. The cross-linked regions are insoluble and remain elevated when the non-cross-linked regions are subsequently washed off. However, today more and more rubber-like printing forms are also directly engraved with a laser that ablates material, and the printing elements are thereby left raised.

A device that is suitable for laser engraving of flexographic printing forms is known from DE 101 16 672 A1, for example.

The printing forms are normally provided as printing plates or in sleeve form (sleeves) and in both cases are ultimately applied on a printing form cylinder and driven in rotation in the printing machine.

In flexographic printing the printing elements are additionally normally provided as raster points, which is different than in classical book printing. Given light tone values (and thus lesser print density) this means that relatively elevated raster points spaced relatively far from one another protrude from a floor relatively in a lighter or even in a medium tone value region. Moreover, in flexographic printing a relatively low-viscosity, thin fluid ink is used, whereby the properties of the ink are also for the most part matched to the respective printing substrate (which can come from a relatively large spectrum in flexographic printing, in particular can comprise absorbent and non-absorbent printing substrates).

Problems can arise in the printout in the printing machine due to this configuration, in particular in specific print density regions. For example, a problem can exist in that ink accumulates into larger drops on the floor and flows together and concentrates, which drops then “spray” uncontrolled onto the printing substrate due to the centrifugal force of the printing form rotating in the printing machine and lead to spotted ink delivery on the printing substrate.

### SUMMARY

It is an object to better control the ink on a letterpress printing form.

More generally it is an object to provide a letterpress printing form that overall behaves in a more controlled and/or predictable manner in terms of its printing properties upon printing.

In a letterpress printing form, at least one region at a floor of the printing form is formed between printing elements to reduce a likelihood that printing ink drops which may form at the floor between the printing elements could detach from the floor and result in an undesired ink deposit on a surface being printed.

### BRIEF DESCRIPTION OF THE DRAWINGS

FIG. 1 shows a section through a flexographic printing form with two printing elements in a side view as a first preferred embodiment;

FIG. 2 shows a section through a flexographic printing form with two printing elements in a side view as a second embodiment;

FIG. 3 illustrates a section through a flexographic printing form with two printing elements in a side view as a third embodiment;

FIG. 4 shows a section through a flexographic printing form with two printing elements in a side view as a fourth embodiment;

FIG. 5 shows a section through a flexographic printing form with two printing elements in a side view as a fifth embodiment;

FIG. 6 shows a section through a flexographic printing form with two printing elements in a side view as a sixth embodiment of the invention,

FIG. 7 illustrates a plan view of a section from a flexographic printing form as a seventh embodiment; and

FIG. 8 shows a printing element in a perspective view similar to as in the exemplary embodiment according to FIG. 7.

### DESCRIPTION OF THE PREFERRED EMBODIMENT

For the purposes of promoting an understanding of the principles of the invention, reference will now be made to the preferred embodiment/best mode illustrated in the drawings and specific language will be used to describe the same. It will nevertheless be understood that no limitation of the scope of the invention is thereby intended, and such alterations and further modifications in the illustrated device and such further applications of the principles of the invention as illustrated as would normally occur to one skilled in the art to which the invention relates are included.

A first preferred embodiment provides that an essentially uniform, uninterrupted floor level does not exist everywhere in the interstices between the elevated printing elements. For example, excessive ink that does not adhere or did not remain adhered to the higher-situated surfaces of the printing elements can collect at such a uniform floor level. This excess ink is theoretically freely mobile on this floor. However, due to adhesion forces at the floor of the printing form thin ink films will remain adhered so strongly that the ink will not yield to the centrifugal force upon the rotation of the printing form. However, there is also effectively a competition between adhesion forces and cohesion forces. Due to the cohesion forces, larger ink accumulations therefore tend to join into drops, contrary to the adhesion forces. However, such a large centrifugal force can then also act on such drops that such a drop can no longer be held on the floor of the printing form by the adhesion force acting on it. This can lead to unwanted ink sprays on the printing substrate.

The technique of the preferred embodiment advantageously initially breaks up the uniform floor level in that regions between printing elements also protrude above the floor. These can provide further adhesion surfaces for the ink and also act as “breakwaters”, in any case as “ink surface breaks”. The described spray risk can thereby already be remedied or reduced.

The elevated regions can exist as a structure of the printing form floor. For example, the floor can have fluctuations that are wavy, pebbled, hilly or in any other form. However, it can also be provided that the region protruding above the floor is designed as a more or less precisely localizable and definable, more or less a pronounced elevation.

It is advantageously provided that the elevated region is designed to be less elevated than a printing element or the printing elements so that these additional elevated regions do not also print. However, it has been shown that it is also not necessarily harmful when these elevated regions project as high as the printing elements because, depending on the ink, adhesion, cohesion and shape of the elevated regions no harmful ink transfer to the printing substrate occurs in spite of a greater height.

The elevated region can, for example, be designed as a free-standing element; however, it can also be formed connected with a base of a printing element, for example. It can thereby be connected at the base or be formed fused with a base of a printing element or be integrated into a base region of a printing element. The base of the printing element can be designed with a protuberance or the like to form an elevated region. However, further different embodiments are also conceivable.

A face slope of the base could also be designed differently for the formation of the elevated region, and a base of a printing element could, for example, also receive at least two elevated regions in its peripheral region.

A preferred embodiment could provide that the base is designed cross- or star-shaped in plan view with a plurality of elevated regions in its peripheral region. The printing region surface could in particular be freely designed in practice and this shape could continue downward into the base region or the like. The printing surface region and cross-sections of the base can, however, also be designed entirely independently of one another.

According to a development of the method it is provided that the elevated region is formed extending between two printing elements. It thereby advantageously becomes a real ink separator, such that ink surfaces are forcibly separated into ink surface segments and a free cohesion of the ink of larger surfaces is necessarily arrested. For example, the elevated region can thereby be designed essentially in a bank or web shape or, for example, may also be designed essentially in a wall shape.

A further development of the method is characterized in that a plurality of elevated regions are designed to enclose or form a basin for printing ink.

Via the preferred basin formations the surface that provides excessive ink on the floor of the printing form is bounded and segmented in advance so that an ink quantity can be kept below a threshold at which the danger exists that ink could collect (due to its cohesion) into drops so large that these could be flung off under the effect of centrifugal force.

Such a basin could be designed essentially round in plan view, for example, and thereby be three-dimensionally formed approximately dome-shaped or approximately like a hollow cylinder or approximately in a funnel shape, for example. Manifold further embodiment possibilities are also provided for this. For example, the basin could alternatively also be formed approximately in a honeycomb shape in plan view.

Overall, elevated regions can be formed collectively into a relief structure, for example.

Another development of the invention provides that basins could be collectively formed into a cell structure corresponding or adapted to a respective printing raster.

In the method it could also conceivably proceed that, given formation of a structure from elevated regions, the respective printing elements are designed as elevated regions (thus initially a structure of the floor of the printing form is developed that is optimized for the solution of the object posed further above) and then the printing elements are also provided in this structure (advantageously as raster points) in that these printing regions are advantageously worked out to be somewhat more elevated or protruding.

The method could thus be characterized in that elevated regions formed together with a relief structure are provided or distinguished from the individual regions as printing elements. Whereby, given formation of the structure from elevated regions the respective printing elements are preferably designed as elevated regions.

The method could also be characterized in that a plurality of elevated regions are formed to enclose or form a basin for printing ink; in that basins are formed together into a cell structure corresponding or adapted to a respective printing raster; and in that regions of the elevated regions are provided or distinguished as printing elements, whereby the respective printing elements are preferably formed upon their formation from elevated regions.

A next development is characterized in that the techniques are executed dependent on the tone value or dependent on the print density; in particular, techniques could thus be provided or not be provided to a different extent or in a different manner, in particular in a different printing form region, and thus dependent on the size and distribution of the printing elements, for example.

The method could also be characterized in that the free volume remaining between printing elements is formed in reduced fashion dependent on the raster and/or dependent on the tone value and/or dependent on the printing density. This can occur, for example, in that the floor of the printing form is designed raised.

A development can also in particular provide that bases of printing elements are designed dependent on raster and/or tone value and/or print density. As already presented further above in a somewhat different context (however likewise in a preferred achievement of the posed object), it could be provided, for example, that a side slope of the respective base is variably designed (at least locally); and/or that at least one elevated region is formed connected with a base of a printing element; and/or that the elevated region is joined to the base; and/or that at least one elevated region is molded fused with a base of a printing element; and/or that the base of the printing element is designed with a protuberance or the like to form an elevated region; and/or that a base of a printing element receives at least two elevated regions in its peripheral region, wherein additionally or alternatively the base could be designed cross-shaped or star-shaped in plan view with a plurality of elevated regions in its peripheral region, for example.

As already likewise explained in principle further above, it could also be provided that the elevated region is formed extending between two bases of printing elements; and/or that the elevated region is formed essentially in a bank or web shape; and/or that the elevated region is formed essentially in a wall shape; and/or that a plurality of elevated regions are designed to enclose or form a basin for printing ink.

The basin could be designed essentially round in its plan view and thereby be three-dimensionally designed approximately dome-shaped, for example; or be formed approximately like a hollow cylinder or approximately like a funnel; or the basin could be formed approximately in a honeycomb shape in plan view, for example.

Elevated regions can advantageously be formed collectively into a relief structure.

A development of the method provides that the techniques are preferably implemented only for print densities from approximately 10% up to approximately 50%. It has been shown that, surprisingly, ink sprays can occur even from printing form regions with rather average print density, for example. This can possibly be explained in that in deep tone regions the printing elements themselves are already so voluminous that only a little space remains for excess ink while in very light regions the printing elements are only isolated and there in turn so much space remains for the excess ink that no excessively high cohesion tendency exists, but rather the adhesion on the free floor surface predominates.

Another independent solution of the method is characterized in that the letterpress printing form is designed as a type of rotogravure form with an inverse raster-dependent cup structure, such that webs or web regions between the cups are arranged according to a raster and are provided or distinguished as printing. An optimized floor of the printing form with elevated printing regions also results in the achievement of the posed object, whereby the respective printing elements could preferably be designed as elevated regions given their formation from webs or web regions.

Another independent solution of the method is that the letterpress printing form is inversely formed with an inverse raster such that regions that are typically formed elevated are designed in negative form as depressions and trench structures typically remaining between these regions that are typically formed elevated are negatively formed as elevated webs, and the elevated webs are arranged according to a raster and are provided or distinguished as printing elements.

An optimized floor of the printing form with elevated printing regions also results in the achievement of the posed object, whereby the respective printing elements could preferably be designed as elevated regions given their formation from webs or web regions.

Another independent solution of the method is characterized in that the printing elements are designed capped depending on the point size.

Printing elements behave differently upon printing due to their differing point size and primarily in flexographic printing due to the relative elasticity of the material of the printing form.

A good and uniform printing behavior at all point sizes can in particular be achieved according to a development of the method in that the printing elements are capped such that relatively thin columns rise over relatively thick bases, the height extent of which columns is greater at smaller point sizes than at larger point sizes. The columns are advantageously designed set back from the bases, possibly forming terraces or ledges. The bases can preferably be essentially designed such that they widen conically as they descend.

The ink control of excessive ink on the floor of the printing form is also advantageously benefited via these techniques, for example, since overall less space remains for the excess ink due to the relatively shorter columns in regions of greater print density.

Protection is also independently claimed for a letterpress printing form (in particular a flexographic printing form) that comprises printing elements elevated above a floor, advantageously comprises raster points arranged according to a raster, advantageously a letterpress printing form designed according to the inventive method that, in an independent solution of the posed object, is characterized in that at least one region protruding above the floor is formed between printing elements.

This likewise applies for a letterpress printing form (in particular a flexographic printing form) that comprises printing elements elevated above a floor, advantageously comprises raster points arranged according to a raster, which letterpress printing form, in an independent solution of the posed object, is characterized in that elevated regions collectively form a relief structure from the individual regions provided or distinguished as printing elements.

This likewise applies for a letterpress printing form (in particular a flexographic printing form) that comprises printing elements elevated above a floor, advantageously comprises raster points arranged according to a raster, which letterpress printing form, in an independent solution of the posed object, is characterized in that a plurality of elevated regions are designed to enclose or form a basin for printing ink; in that basins collectively form a cell structure corresponding or adapted to a respective print raster; and in that regions of the elevated regions are provided or distinguished as printing elements.

This likewise applies for a letterpress printing form (in particular a flexographic printing form) that comprises printing elements elevated above a floor, advantageously comprises raster points arranged according to a raster, which letterpress printing form, in an independent solution of the posed object, is characterized in that the free volumes remaining between printing elements are formed reduced dependent on raster and/or tone value and/or print density.

This likewise applies for a letterpress printing form (in particular a flexographic printing form) that comprises printing elements elevated above a floor, which letterpress printing form, in an independent solution of the posed object, is characterized in that the letterpress printing form is designed as a type of rotogravure form with an inversely raster-dependent cup structure, such that webs or web regions are arranged according to a raster between the cups and are provided or distinguished as printing elements.

This likewise applies for a letterpress printing form (in particular a flexographic printing form) that comprises printing elements elevated above a floor, which letterpress printing form, in an independent solution of the posed object, is characterized in that the letterpress printing form is designed inversely with an inverse raster, such that typically elevated regions are designed in negative form as recesses, and trench structures typically remaining between these regions typically formed as elevations are negatively formed as elevated webs, and the elevated webs are arranged according to a raster and are provided or distinguished as printing elements.

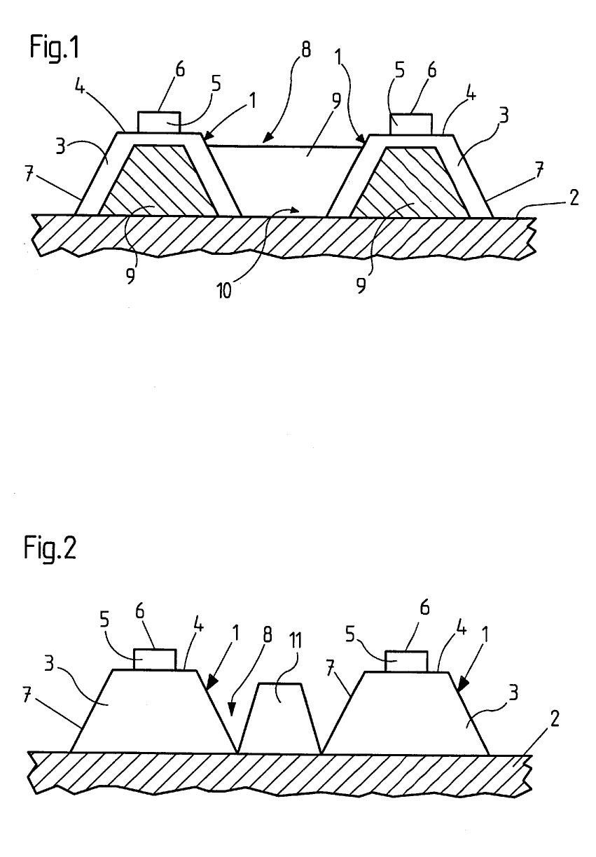

FIG. 1 shows an exemplary embodiment of a segment of a flexographic printing form in section, whereby two printing elements 1 that project from a floor 2 of the printing form are recognizable in a side view. The hatchings in this Figure and in subsequent Figures serve primarily for the clear association of cut surfaces from different regions. The entire presented region of the printing form can, however in principle be formed in one part from the same material, such that the hatchings could also all be of the same type. The forming of such a printing form can preferably occur with a direct engraving using a fiber laser. The fiber laser can sustain a processing focal diameter of less than or equal to 20 μm, advantageously even smaller than or equal to 10 μm, with a clean focusing and a good depth of focus with advantageously a nearly only diffraction-limited laser beam, such that even the finest structures of the printing form and its elements can be prepared.

The printing elements 1 exhibit bases 3 that preferably expand more or less conically as they descend. A column 5 whose top side 6 forms the actual printing surface of the printing element sits set back on the respective base 3, possibly leaving a ledge 4 of the base 3. The bases 3 exhibit sides 7 that in this example have the same slope angles.

Printing elements in a medium tone or print density region should advantageously be represented in FIG. 1. In this region the free space 8 between the printing elements 1 can in particular be critical insofar as excess free printing ink can accumulate to form drops there, which can lead to unwanted sprays onto the printing substrate upon printing.

In the first exemplary embodiment according to FIG. 1 it is therefore provided in a solution to insert elevated regions or structures comprising banks or walls 9 between the bases 3 of the printing elements 1 or to leave the banks or walls 9 upon removal of the material, which banks or walls 9 form basins or bowls 10 between printing elements 1 adjacent to one another, the basins or bowls 10 respectively offering only a limited volume to the printing ink for its cohesion and simultaneously offering the printing ink further surfaces for adhesion, such that a critical drop formation can be avoided. In this exemplary embodiment all printing elements 1 and banks 9 can form a type of cell structure or a relief developed otherwise extending across the printing form.

For example, another embodiment could also appear such that each base 3 receives wall projections 9, however the wall projections 9 do not connect with the wall projections 9 of an adjacent base 3. The critical space 8 between the printing elements 1 would thus also be reduced in its volume and structured in order to avoid an all too free flow and accumulation of printing ink in any case.

Identical elements are designated with the same reference numbers in the following Figures as in FIG. 1.

FIG. 2 shows a second exemplary embodiment in a presentation similar to FIG. 1. However, here additional elevated elements 11 have been placed or left in the space 8 between the printing elements 1 as an alternative solution. The element 11 has only an exemplary shape and extent could also be designed differently with the same function.

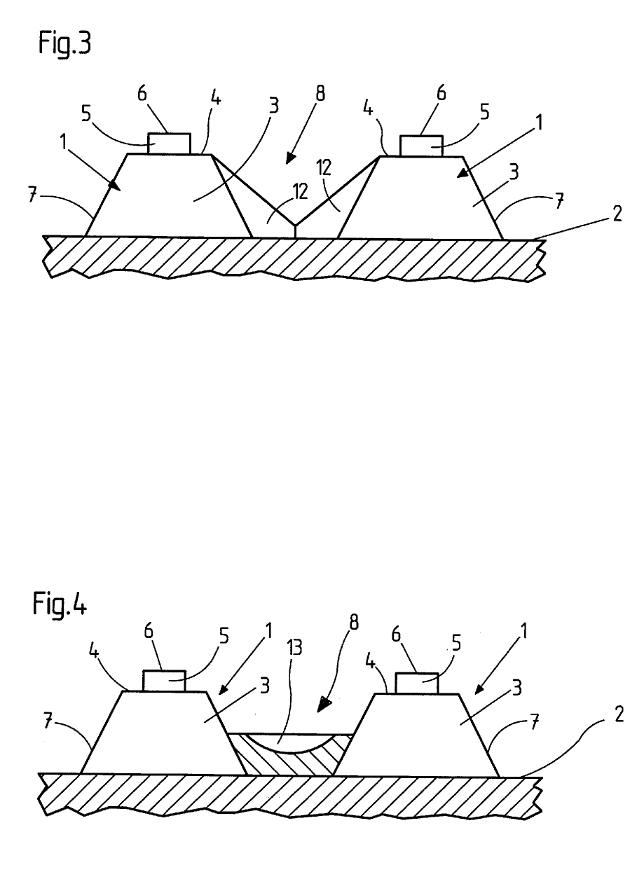

FIG. 3 shows a further exemplary embodiment in which outgrowths 12 are molded on the bases 3 so that the space 8 between them is reduced. Only two exemplary outgrowths or extensions 12 are shown. These could, for example, be arranged in a star shape around each base 3. The slope angle of the sides 7 can also be altered, for example be set flatter. Outgrowths 12 or the like arise in turn when this is implemented locally.

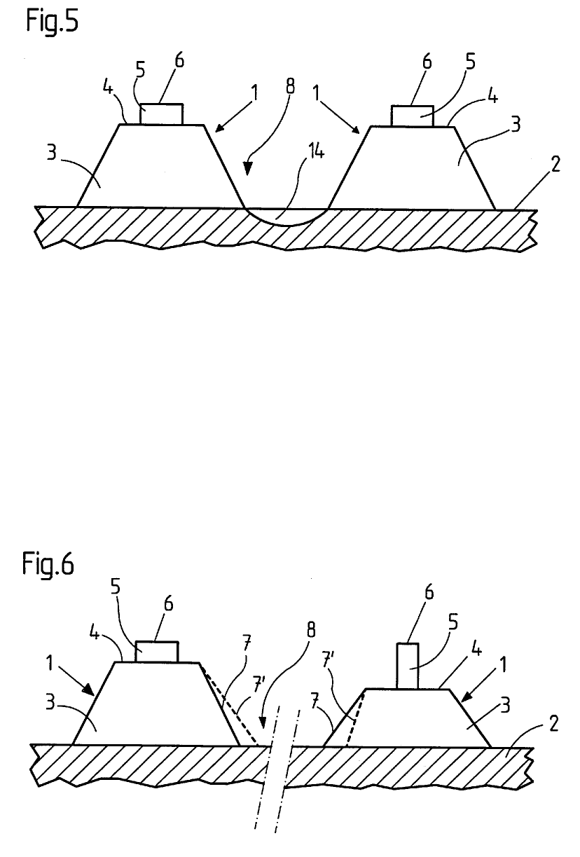

FIG. 4 shows an exemplary embodiment in which an essentially dome-shaped basin 13 is formed for printing ink in the space 8. Such a basin could also be shaped within the floor surface 2 itself because the floor surface could also be advantageously structured. Such an embodiment is indicated in FIG. 5 with a basin or a trough.

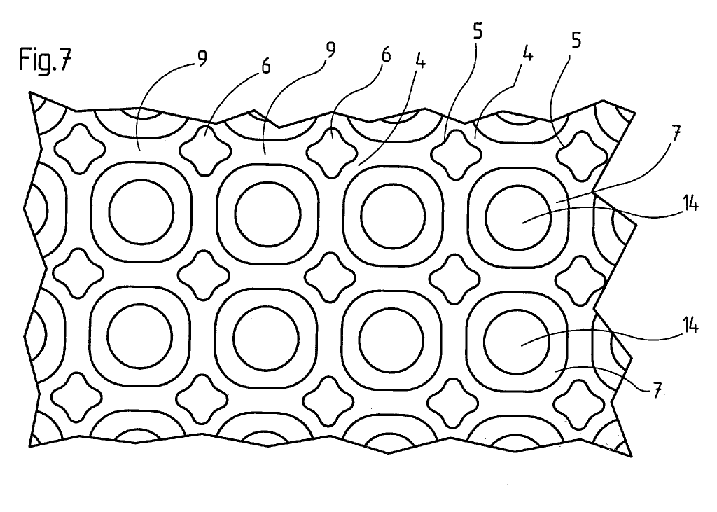

FIG. 6 shows a tone value-dependent base in an exemplary embodiment. Segments of a printing form are shown in section in FIG. 6. A printing element 1 that should in turn be in a medium tone or print density region is shown in side view on the left side of the Figure while a printing element 1 of a lighter tone is shown in side view to the right in FIG. 6. The left printing element essentially corresponds in terms of its shape to the printing element 1 from the preceding Figures. However, here it is indicated with a dashed line 7′ that the side slope of the base 3 can also simply be designed flatter (on all sides) in order to reduce the space 8 in this medium tone region. Contrary to this, given lighter tones as in the right region of FIG. 6 the side 7′ of the base could even be placed steeper (on all sides) because problematic cohesions of the printing ink normally do not occur in this region given these larger spaces 8; rather, the entire space 8 between the printing elements 1 is perhaps so large and essentially isotropic that the ink behaves indifferently here and a strong adhesion occurs on the relatively large floor surface 2, which prevents a local cohesion into drops. In regions of increasing lightness it is therefore more advantageous to achieve this larger expansion of the space 8 earlier instead of reducing it as in the medium region. The sides 7 are therefore better steeper instead of flatter.

Moreover, it is indicated that the column 5 of the lighter tone can additionally begin already quite lower than given the medium tone to the left, such that the space 8 is also likewise already increased at higher levels. Moreover, the printout behavior of the relatively small surface 6, which otherwise could advantageously lie at a somewhat lower level than the surface 6 given a medium or deep tone in order to avoid a too-large print point enlargement of this small surface 6 upon printing, advantageously improves since this relatively thin column 5 is relatively flexible. The column length could be set in steps dependent on tone value.

FIG. 7 shows a further preferred exemplary embodiment according to type.

Shown is a plan view of a section from a flexographic printing form. Recognizable here in plan view is a regular structure or a relief that extends across the printing form or at least printing form regions or takes up these.

For example, a cell or comb structure with basins 14 (or also 10 or 13) is specified. The edges of these basins can, for example, be base sides 7 or even ground surfaces 2. The cells are enclosed by banks 9 or base outgrowths or extensions 12 or the like that in total are networked into a type of grid structure. Columns 5 with elevated, protruding surfaces 6 can be arranged as printing element regions at the intersection points. These surfaces can moreover have nearly arbitrary shapes in plan view and also have offshoots, whereby the surface shapes 6 and the base shapes 7 do not necessary have to be correlated with one another. A type of star or flower shape was assumed here for the surfaces 6 by way of example. Preceding Figures appear to adopt more circular round surfaces 6 which, as said, is however not absolutely mandatory The printing elements can be relatively freely executed in three dimensions, which in particular can also be implemented well and precisely and quickly with a fiber laser.

In this context it should above all be made clear that given the preferred embodiment, a relief structure as a solution can conceivably be assumed in that the printing elements are then advantageously provided as raster points for which the relief structure could be designed dependent on the raster, for example with regard to desired line intervals, raster angles and so on. In reverse, however, printing elements can also be conceivably assumed that are more or less structure-forming, more or less “grow together” in the base region or are expanded by additional elevated intermediate elements 11.

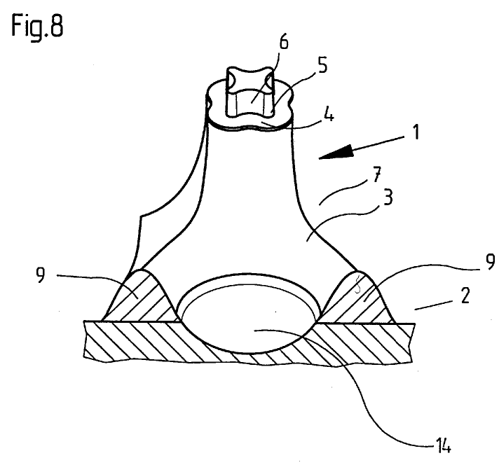

Finally, FIG. 8 shows a printing element 1 in perspective view, similar to as it could be cut from the exemplary embodiment according to FIG. 7.

The base 3 ascends like a tree stump with star-shaped roots running out in banks 9 that surround a basin 14 in the floor 2. Such a base could moreover also be freestanding on the floor 2 with its star-shaped outgrowths without its outgrowths connected with outgrowths of adjacent base 3 to form banks.

Moreover, it is reminded again at this point that the printing form could in particular be provided as a plate, tube or sleeve, and that the printing form could be arbitrarily engraved or exposed and washed off, thus for example also with material cross-linking under UV. Direct laser engraving with a fiber laser on a round form is only at the moment viewed as a best mode, but not as limiting a scope of the invention.

While a preferred embodiment has been illustrated and described in detail in the drawings and foregoing description, the same is to be considered as illustrative and not restrictive in character, it being understood that only the preferred embodiment has been shown and described and that all changes and modifications that come within the spirit of the invention both now or in the future are desired to be protected.

1. A method for production of a letterpress printing form, said letterpress printing form comprising printing elements elevated above a floor of the printing form, comprising the steps of:
creating a relief structure in a material of the printing form to form the letterpress printing form, said relief structure forming said printing elements as columns extending from the floor with printing surfaces, and wherein structured regions are provided at the floor associated with the printing elements to reduce a likelihood that printing ink drops which may form at said floor between said printing elements could detach from the floor and result in an undesired ink deposit on a surface being printed.

2. A method according to claim 1 wherein said structured regions comprise elevated regions which protrude above said floor.

3. A method according to claim 2 wherein the elevated regions are less elevated than the printing elements.

4. A method according to claim 2 wherein the elevated regions comprise free-standing elements.

5. A method according to claim 2 wherein the elevated regions extend radially outwardly from bases of the printing elements.

6. A method according to claim 2 wherein the elevated regions are connected at bases of the printing elements.

7. A method according to claim 2 wherein the elevated regions are fused with bases of the printing elements.

8. A method according to claim 2 wherein the elevated regions are integrated with bases of the printing elements.

9. A method according to claim 2 wherein the elevated regions comprise protuberances in bases of the printing elements.

10. A method according to claim 2 wherein at least one side slope of bases of the printing elements is variably designed, at least locally, for formation of the elevated regions.

11. A method according to claim 2 wherein bases of the printing elements receive at least two elevated regions in their peripheral regions.

12. A method according to claim 11 wherein the bases are cross- or star-shaped in plan view with a plurality of elevated regions at their peripheral regions.

13. A method according to claim 2 wherein the elevated regions are formed extending between adjacent printing elements.

14. A method according to claim 2 wherein the elevated regions comprise a bank, a wall, or a web-shape projection of a base of the printing elements.

15. A method according to claim 2 wherein the elevated regions are in a wall shape.

16. A method according to claim 2 wherein a plurality of the elevated regions form basins for the printing ink which may collect at the floor.

17. A method according to claim 16 wherein the basins are substantially round in plan view.

18. A method according to claim 17 wherein the basins are approximately dome-shaped.

19. A method according to claim 17 wherein the basins are approximately shaped as a hollow cylinder.

20. A method according to claim 17 wherein the basins are approximately in a funnel shape.

21. A method according to claim 16 wherein the basins are formed approximately in a honeycomb shape in plan view.

22. A method according to claim 21 wherein the elevated regions are formed collectively in the relief structure.

23. A method according to claim 16 wherein the basins are collectively formed into a cell structure corresponding or adapted to a respective printing raster, and wherein said printing elements correspond to points of the printing raster.

24. A method according to claim 1 wherein the printing elements form points of a raster.

25. A method of claim 1 wherein the letterpress printing form comprises a flexographic printing form.

26. A method of claim 1 wherein the relief structure is created by laser engraving of the material of the form.

27. A method of claim 26 wherein the laser engraving is direct.

28. A method of claim 1 wherein the structured regions comprise depressed regions extending below the floor.

29. A method according to claim 1 wherein the structured regions are associated with certain printing elements but not other printing elements based on tone value or print density.

30. A method according to claim 29 wherein the structured regions associated with some of the printing elements differ from elevated regions associated with other of the printing elements based on tone value or print density.

31. A method of claim 1 wherein between some of the printing elements the floor of the printing form is higher than between other printing elements.

32. A method of claim 2 wherein a side slope of at least one side of bases of the printing elements are provided differently for different printing elements.

33. A method of claim 2 wherein a base of the printing elements has at least two of the elevated regions in its peripheral regions.

34. A method according to claim 2 wherein a base of the printing elements is cross-shaped or star-shaped in plan view with a plurality of the elevated regions in its peripheral region.

35. A method of claim 2 wherein the elevated regions are provided only for print densities from approximately 10% to 50%.

36. A method according to claim 1 wherein the printing elements have a narrowed top side as the printing surface.

37. A method according to claim 1 wherein the printing elements are relatively thin columns rising over relatively thick bases, a length of the columns being greater and a thickness of the columns being thinner at smaller point sizes than at larger point sizes.

38. A method according to claim 37 wherein the columns are set back from the bases.

39. A method according to claim 1 wherein the printing elements have bases which widen conically as they descend.

40. A method according to claim 1 wherein the relief structure is formed by use of a fiber laser.

41. A method according to claim 40 wherein the fiber laser has a spot size of 20 μm or less.

42. A method according to claim 41 wherein the fiber laser has a spot size of 10 μm or less.

43. A method for production of a letterpress printing form by use of at least one processing unit for milling material of the printing form, said letterpress printing form comprising printing elements elevated above a floor of the printing form, comprising the step of:
engraving a relief structure in a material of the printing form with a direct fiber laser engraving in said material using a spot size of 20 μm or less, said engraved relief structure forming said printing elements, said printing elements comprising columns extending from the floor with printing surfaces, and wherein elevated regions are provided extending above the floor and associated with the printing elements but not extending as high as the printing elements to reduce a likelihood that printing ink drops which may form at said floor between said printing elements could detach from the floor and result in an undesired ink deposit on a surface being printed.

44. A method for production of a flexographic printing form comprising a plurality of printing elements elevated above a floor of the printing form, comprising the step of:
engraving a relief structure to form the letterpress printing form, said relief structure forming said printing elements as columns extending from the floor with printing surfaces, the printing elements being located at points of a printing raster, and wherein elevated regions having a height above said floor less than said printing elements and comprising banks forming basins associated with the printing elements to reduce a likelihood that printing ink drops which may form at said floor between said printing elements could detach from the floor and decrease a quality of printing by the printing form.

45. A method for production of a letterpress printing form, said letterpress printing form comprising printing elements elevated above a floor of the printing form, comprising the step of:
creating a relief structure in a material of the printing form to form the letterpress printing form, said relief structure forming said printing elements as columns extending from the floor with printing surfaces, and wherein an area between printing elements is reduced by reducing a size of bases of the columns dependent on a raster, dependent on tone value, or dependent on printing density to reduce a likelihood that printing drops which may form at said floor between said printing elements could detach from the floor and decrease the quality of printing by the printing form.

46. A system for letterpress printing, comprising:
a letterpress printing form having a relief structure with a floor with printing elements as columns extending from the floor with printing surfaces; and
structured regions at the floor associated with the printing elements and being shaped and dimensioned to reduce a likelihood that printing ink drops which may form at said floor between said printing elements could detach from the floor and result in an undesired ink deposit on a surface being printed.

47. A system according to claim 46 wherein said structured regions comprise elevated regions which protrude above said floor.

48. A system according to claim 47 wherein the elevated regions are less elevated above the floor than the printing elements.

49. A system according to claim 47 wherein the elevated regions comprise free-standing elements.

50. A system according to claim 47 wherein the elevated regions are connected at bases of the printing elements.

51. A system according to claim 47 wherein at least one side slope of bases of the printing elements is extended for formation of the elevated regions.

52. A system according to claim 47 wherein the elevated regions are formed extending between adjacent printing elements.

53. A system according to claim 47 wherein the elevated regions comprise a bank.

54. A system according to claim 47 wherein the elevated regions form basins for the printing ink which may collect at the floor.

55. A system according to claim 46 wherein the printing elements form points of a raster.

56. A system of claim 46 wherein the letterpress printing form comprises a flexographic printing form.

57. A system of claim 46 wherein the structured regions comprise depressed regions extending below the floor.

58. A system of claim 47 wherein a side slope of at least one side of the bases of the printing elements are provided differently for different printing elements.

59. A system of claim 47 wherein the elevated regions are provided only for print densities from approximately 10% to 50%.

60. A system of claim 46 wherein each of the printing elements has a narrow top side as the printing surface.

61. A system according to claim 46 wherein the printing elements are relatively thin columns rising over relatively thick bases, a length of the columns being greater and a thickness of the columns being thinner at smaller point sizes than at larger point sizes.

62. A system according to claim 61 wherein the columns are set back from the bases.

63. A system according to claim 46 wherein the printing elements have bases which widen conically as they descend.

64. A system for flexographic printing, comprising:
a flexographic printing form having a relief structure forming a plurality of printing elements elevated above a floor of the printing form, structure forming said printing elements comprising columns and the printing elements being located at points of a print raster; and
elevated regions in said relief structure having a height above the floor which is less than said printing elements and comprising banks forming basins associated with the printing elements to reduce a likelihood that printing ink drops which may form at said floor between said printing elements could detach from the floor and decrease a quality of printing by the printing form.

65. A system for letterpress printing, comprising:
a letterpress printing form having a relief structure with printing elements as columns extending above the floor with printing surfaces; and
an area between printing elements being reduced by reducing a size of bases of the columns dependent on a raster, dependent on tone value, or dependent on printing density to reduce a likelihood that printing drops which may form at said floor between said printing elements could detach from the floor and decrease the quality of printing by the printing form.
